(19) United States
(12) Patent Application Publication
(10) Pub. No.: US 2010/0122464 A1
(43) Pub. Date: May 20, 2010

(54) Razor Cartridge with Skin Engaging Member

(76) Inventors: Thilivhali Tshikovhi Ndou, Framingham, MA (US); Neville Sonnenberg, Newton, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/271,320

(22) Filed: Nov. 14, 2008

(51) Int. Cl. B26B 19/40; B26B 19/38

(52) U.S. Cl. 30/41; 30/77; 30/84

(57) ABSTRACT

The present invention is directed to a razor cartridge including a guard, a cap and a plurality of blades each with sharpened edges located between the guard and the cap. The cap includes a cap edge positioned nearest the blades and an erodible skin engaging member. A cap blade is positioned nearest the cap and an adjacent blade is positioned immediately adjacent to the cap blade and between the cap blade and the guard. The skin engaging member includes at least one upper layer and a base layer positioned below the upper layer. The upper layer erodes during shaving exposing the upper surface of the base layer which is positioned relative to the cap edge such that when the upper layer has eroded the cap blade edge has a final exposure defined by the adjacent blade edge, the cap edge and the upper surface of the base layer.

### FIELD OF THE INVENTION

The present invention relates to a razor cartridge and more particularly to a razor cartridge with a skin engaging member or shaving aid strip.

### BACKGROUND OF THE INVENTION

In shaving systems of the wet shave type, factors such as the frictional drag of the razor across the skin, the force needed to sever hairs, and irritation of pre-existing skin damage can create a degree of shaving discomfort. Discomfort, and other problems accompanying wet shaving systems, can be alleviated by the application of shaving aids to the skin. Shaving aids may be applied prior to, during, or after shaving. A number of problems accompany the use of pre- and post-applied shaving aids. Pre-applied-shaving aids can evaporate or can be carried away from the site of application by repeated strokes of the razor. Post-applied-shaving aids are not present on the skin during shaving and thus their application may be too late to prevent an unwanted affect. Both pre-applied and post-applied shaving aids add additional steps to the shaving process.

Proposals have been made to incorporate a shaving aid e.g., lubricant, whisker softener, razor cleanser, medicinal agent, cosmetic agent or combination thereof, into a razor, e.g., by depositing a shaving aid in a recess on the razor, by incorporating a shaving aid directly into one or more molded polymeric components of the razor, by adhesively securing a shaving aid composite to the razor, and by use of a mechanical connection between a shaving aid composite and the razor. A water-soluble shaving aid, e.g., polyethylene oxide, has been mixed with a water-insoluble material, e.g., a polystyrene polymer, to form an insoluble polymer/soluble skin engaging member also known as a shaving aid strip, a shaving aid composite, a lubricating strip. The skin engaging member has been mounted on razor and shaving cartridge structures, adjacent the shaving edge or edges, of single or multiple blade shaving systems. Upon exposure to water, the water-soluble shaving aid leaches from the skin engaging member onto the skin.

One problem associated with razor cartridges is that a user has no indication as to when the razor cartridge is nearing the end of its' optimal shave performance and should be replaced. One solution to this problem has been to utilize the skin engaging member or lubricating strip to provide an indication or signal to the user that the cartridge has reached the end of its' optimal shave performance and should be replaced. Such solutions include the use of a two colored lubrication strip. As the user shaves the lubrication member wears away. Typically, in two color systems one of the layers, e.g., the first layer which may be colored blue, is positioned to wear away first thus exposing the second layer which has a different color, e.g., white, than the first layer. This provides an indication to the user that the razor cartridge should be replaced.

One problem associated with the two color lube strip indicators is that they do not provide an exacting correlation between the indication and or signal to the user and the change from an optimal shave performance to a sub-optimal shave performance. For example, the indication changes even though the optimal shave performance may have passed long ago or has yet to pass. There is a need to provide the user with an indication that correlates with the change between an optimal shave performance and a sub-optimal shave performance.

### SUMMARY OF THE INVENTION

The present invention is directed to a razor cartridge comprising a guard, a cap and a plurality of blades each with sharpened edges located between the guard and the cap. The cap comprises a cap edge positioned nearest the blades and an erodible skin engaging member. The plurality of blades comprise a cap blade defining a blade edge nearest the cap and an adjacent blade defining a blade edge positioned immediately adjacent to the cap blade and between the cap blade and the guard. The skin engaging member comprises at least one upper layer comprising an erodible skin engaging layer of a first color. The upper layer has an upper surface, a lower surface and a first thickness dimension. The skin engaging member comprises a base layer positioned below the upper layer comprising an erodible skin engaging layer of a second color different from the first color. The base layer has an upper surface, a lower surface and a thickness dimension. During shaving the upper layer eroding exposing the upper surface of the base layer, the upper surface of the base layer being positioned relative to the cap edge such that when the upper layer has eroded the cap blade edge has a final exposure defined by the adjacent blade edge, the cap edge and the upper surface of the base layer.

Preferably, the first color is green. Preferably, the second color is red. The second color may be white.

The upper layer and the base layer preferably each comprise a solid polymeric material. Preferably, the upper layer and the base layer each comprise a water soluble shaving aid and a water insoluble polymer.

The upper surface of the upper layer is positioned relative to the cap edge such that prior to use the cap blade edge has a first exposure defined by the adjacent blade edge and the upper surface of the upper layer.

The final exposure is greater than first exposure.

The upper layer may comprise two layers, three layers or more.

During shaving the upper layer erodes exposing said upper surface of said base layer to provide a color change that signals to a user that the cartridge should be replaced

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a perspective view of a razor cartridge which includes a skin engaging member of the present invention.

FIG. 2 is a sectional view taken along line 2-2 of FIG. 1.

FIG. 3 is a perspective view of the skin engaging member included in the razor cartridge depicted in FIG. 1.

FIG. 4 is a side elevation view of the skin engaging member of FIG. 3.

FIG. 5 is a sectional view of a razor cartridge identical to that of FIG. 2, depicting the razor cartridge prior to use.

FIG. 6 is a sectional view of a razor cartridge identical to that of FIG. 2, depicting the razor cartridge after several shaves.

FIG. 7 is a sectional view of a razor cartridge identical to that of FIG. 2, depicting the razor cartridge after numerous shaves.

FIG. 8 is a side elevation view of an alternative skin engaging member of the present invention.

FIG. 9 is a side elevation view of an alternative skin engaging member of the present invention.

### DETAILED DESCRIPTION OF THE INVENTION

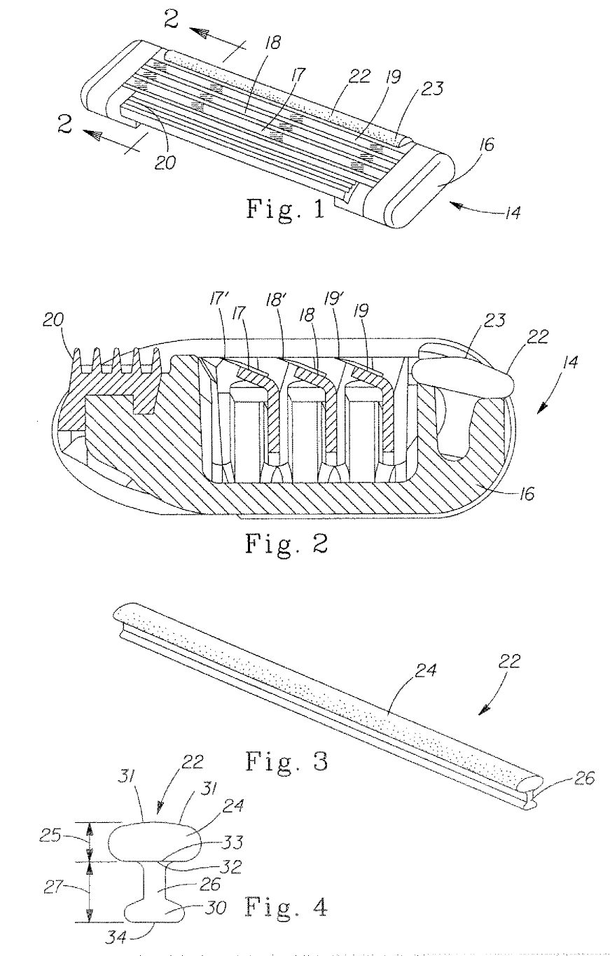

Referring to FIGS. 1, and 2 the razor cartridge 14 includes housing 16, which carries three blades 17, 18 and 19, a finned elastomeric guard 20, and a skin engaging member or shaving aid strip 22 located on a skin-engaging portion (in this case the cap 23) of the cartridge 14. The blades 17, 18 and 19 are positioned between the guard 20 and the cap 23. The blades 17, 18 and 19, each have a sharpened edge, 17′, 18′ and 19′, respectively.

Blade 19 is referred to as the cap blade as it is positioned nearest the cap 23. Blade 18 is referred to as an adjacent blade given its' proximity to the cap blade 19. Adjacent blade 18 is positioned adjacent to the cap blade 19 and between the cap blade 19 and the guard 20. While the razor cartridge is shown with three blades, the cartridge may include two, three, four, five, six blades, etc.

The skin engaging member 22 is in the form of a narrow elongated strip of dimensions suitable for placement on a razor cartridge. The skin engaging member 22 may be about 2.5 cm to about 3.7 cm in length, and about 0.15 cm to about 0.35 cm in width. The skin engaging member 22 is locked in an opening in the rear of the cartridge 14. The skin engaging member may be secured to cartridge 14 by other known methods such as ultrasonic welding or gluing. While shown at the rear portion of this particular razor cartridge, the skin engaging member may be located at any skin-engaging portion of the cartridge and may be fabricated in any size or shape deemed appropriate. For example, the skin engaging member can be incorporated into razor cartridges such as the Fusion®, Venus®, Mach 3®, Sensor Excel®, Atra Plus® and Custom Plus® razors sold by The Gillette Company, as well as in other commercial razor cartridges.

Referring to FIGS. 3 and 4, skin engaging member 22 includes an exposed lengthwise-extending erodible skin engaging upper layer or portion 24 and a lengthwise-extending erodible skin engaging base layer or portion 26 positioned below the upper layer 24. The base layer 26 preferably extends under the upper layer 24 and provides support for upper layer 24. The boundary between respective layers may approximate a plane as shown. However, the boundary between respective layers may approximate other shapes such as curvilinear, arcuate either convex or concave. Base layer 26 also includes connecting portion 30 which serves to lock the skin engaging member into a mating receiving portion of the cartridge.

The upper layer 24 has an upper surface 31 and a lower surface 32. The base layer 26 has an upper surface 33 and a lower surface 34. Upper surface 31 is the exposed surface of skin engaging member 22 facing the user prior to use. Lower surface 32 faces and directly contacts upper surface 33.

Each layer or portion of the skin engaging member or shaving aid strip 22 preferably comprises a solid polymeric material. Each layer of the skin engaging member 22 preferably comprises a lubricious water-soluble polymer as the main shaving aid and a water-insoluble polymer to serve as a matrix in which the water-soluble polymer is dispersed. A layer having a greater amount of water-soluble polymer will wear at a faster rate or more quickly than a layer with a lower amount of water-soluble polymer, all other things being equal. Preferably, the upper layer will comprise a greater amount of water-soluble polymer in percent by weight than the base layer. The base layer which acts to hold the skin engaging member in place within the cartridge and provides support for the upper layer preferably comprises a lesser amount of water-soluble polymer by weight than the upper layer.

Preferably, the upper layer or portion 24 will comprise about 0% to about 30%, more preferably about 10% to about 25%, by weight water-insoluble polymer, and about 65% to about 95%, more preferably about 65% to about 95%, by weight lubricious water-soluble polymer. Preferably, the base layer or portion 26 will comprise about 20% to about 60%, more preferably about 25% to about 40%, by weight water-insoluble polymer, and about 50% to about 85%, more preferably about 55% to about 75%, by weight lubricious water-soluble polymer.

Typical lubricious water-soluble polymers include polyethylene oxide, polyvinyl pyrrolidone, polyacrylamide, modified hydroxyalkyl cellulose, polyvinyl imidazoline, polyvinyl alcohol, polysulfone and polyhydroxyethylmethacrylate. The preferred lubricious water-soluble polymer is polyethylene oxide. The more preferred polyethylene oxides generally are known as POLYOX (available from Union Carbide Corporation) or ALKOX (available from Meisei Chemical Works, Kyoto, Japan). These polyethylene oxides will preferably have molecular weights of about 100,000 to 8 million daltons, most preferably about 300,000 to 5 million daltons. It is preferred to use a blend of polyethylene oxides, typically a blend having at least one polyethylene oxide having a molecular weight in the range of 100,000 to 500,000 and at least one polyethylene oxide having a molecular weight in the range of 3 million to 8 million. The most preferred polyethylene oxide comprises a blend of about 40% to 80% by weight of polyethylene oxide having an average molecular weight of about 5 million (e.g. POLYOX COAGULANT) and about 60% to 20% of polyethylene oxide having an average molecular weight of about 300,000 (e.g. POLYOX WSR-N-750). A 60:40 blend of these two polyethylene oxides (5 million: 300,000) is especially preferred.

Suitable water-insoluble polymers which can be used include polyethylene, polypropylene, polystyrene, butadiene-styrene copolymer (e.g. medium and high impact polystyrene), polyacetal, acrylonitrile-butadiene-styrene copolymer, ethylene vinyl acetate copolymer, polyurethane and blends thereof such as polypropylene/polystyrene blend or polystyrene/impact polystyrene blend. The more preferred water-insoluble polymer is polystyrene, preferably a general purpose polystyrene, such as NOVA C2345A, or a high impact polystyrene (i.e. polystyrene-butadiene), such as NOVA 5410 or Total 975E. The strip or any portion should contain a sufficient quantity of water-insoluble polymer to provide adequate mechanical strength, both during production and use.

The upper layer or portion 24 of the shaving aid strip 22 may also include a material which allows it to wear more quickly and/or which facilitates the inclusion of relatively high levels of water-soluble polymer. One such material is polycaprolactone, as described in copending application U.S. Ser. No. 09/506,628 (Docket No. 8070) filed on Feb. 18, 2000. Preferably, the polycaprolactone will be included in an amount of about 1% to about 10% by weight. Polycaprolactones are available from PERSTOP/SOLVAY under the name CAPA® polymers (e.g., 6100, 6505, 65065 and 6800). Preferably, the polycaprolactone will have a molecular weight between about 1000 and about 80,000 daltons, more preferably between about 30,000 and 60,000 daltons, and most preferably about 50,000 daltons.

The shaving aid strip, or any portion, also may contain other conventional shaving aid ingredients, such as low molecular weight water-soluble release enhancing agents such as polyethylene glycol (MW<10,000, e.g., 1-10% by weight PEG-100), water-swellable release enhancing agents such as cross-linked polyacrylics (e.g., 2-7% by weight), antioxidants, preservatives, botanical oils, vitamin E, aloe, cooling agents, essential oils, beard softeners, astringents, medicinal agents, mineral oil, etc.

The upper layer 24 comprises a first color. The first color is preferably green. The upper layer 24 is preferably colored green with a green dye or pigment such as phthalocyanine pigment green 7. The base layer 26 comprises a second color which is different from the first color. The second color is preferably white. The base layer 26 is preferably colored white with a dye or pigment such as titanium dioxide. The base layer 26 may be colored red with a dye or pigment such as DPP pigment red 254

A wear indicating effect is produced when the upper and base layers are made of disparately colored materials (e.g. green colored upper layer and white or red colored base layer). Upon use, the upper layer 24 at the skin engaging surface is typically worn off (or eroded) through use. With sufficient use, the base layer 26 is exposed, thus providing the user with an indication via the color change from the first color to the second color that the razor cartridge and/or skin engaging surface have reached the end of their optimal effective life or optimal performance and should be replaced.

The colorants may be released by leaching or abrasion. A layer may contain, for example, between about 0.1% and about 5.0% (preferably between about 0.5% and 3%) colorant by weight.

The first layer 24 has a first thickness dimension 25. Preferably the first thickness dimension 25 is from about 0.2 to about 1.0 mm. The base layer 26 has a second thickness dimension 27. Preferably, the first thickness dimension 25 is less than the second thickness dimension 27. Preferably, the second thickness dimension 27 is from about 1.0 to about 3.0 mm.

Skin engaging members of the present invention may be fabricated by any appropriate method, including injection molding and extrusion, the latter being preferred. All of the components of the strip are blended prior to molding or extrusion. For best results, it is preferred that the components are dry.

The skin engaging member may be formed by combining extruders via an input transition die assembly. The upper layer may be delivered through a ¾ inch diameter Brabender PL2200 Plasti-corder, with a pressure of about 2500-8000 psi, a rotor speed of about 12 to 25 rpm, and a temperature of about 2450-380° F. The extruder may be ½ to 1 inch in diameter. The base layer may be delivered through a 1.5 inch diameter Davis Standard with a pressure of about 2500-3500 psi, a rotor speed of about 10 to 20 rpm, and a temperature of about 290°-385° F. The extruder may be ¾ to 1.5 inch in diameter. The die assembly may be between about 350°-420° F. The feed throat sections for the extruders may be cooled to about 62° F. The output speed may be between about 30 to 70 feet per minute.

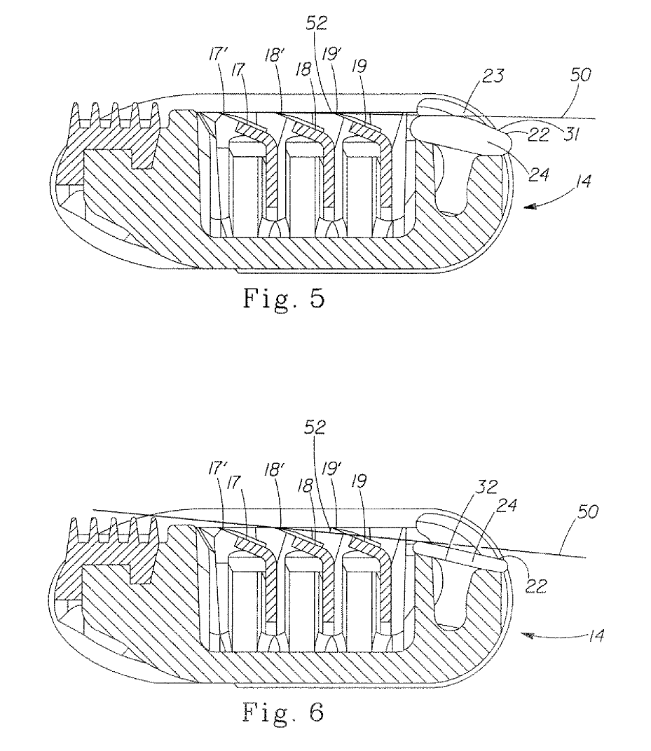

Referring now to FIGS. 5-7, the blade exposure is defined to be the perpendicular distance or height of the blade edge measured with respect to a plane tangential to the skin contacting surfaces of the blade unit elements next in front of and next behind the blade edge. Therefore, for the razor cartridge 14 of the present invention, the exposure of the cap blade 19 is measured with reference to a plane 50 tangential to the edge 18′ of the adjacent blade 18 and either the exposed surface of the skin engaging member 22 or the cap edge 48.

In FIG. 5 the razor cartridge 14 is shown prior to use. The exposure 52 of the cap blade 19 prior to use in this embodiment is about +0.2 mm. The exposure of the cap blade 19 prior to use is measured with reference to plane 50 tangential to the edge 18′ of the adjacent blade 18 and the upper surface 31 of the upper layer 24. Prior to use the upper surface 31 of the upper layer 24 is the exposed surface of the skin engaging member 22.

In FIG. 6 the razor cartridge 14 is shown after several shaves. The exposure 52 of the cap blade 19 after several shaves is about +0.25 mm. The exposure of the cap blade 19 after several shaves is measured with reference to plane 50 tangential to the edge 18′ of the adjacent blade 18 and the exposed surface of the upper layer 24. After several shaves the exposed surface is located between the upper surface (no longer present) and the lower surface 32 of the upper layer 24. After several shaves a portion of the upper layer 24 has eroded away and thus the original upper surface 31 is no longer present.

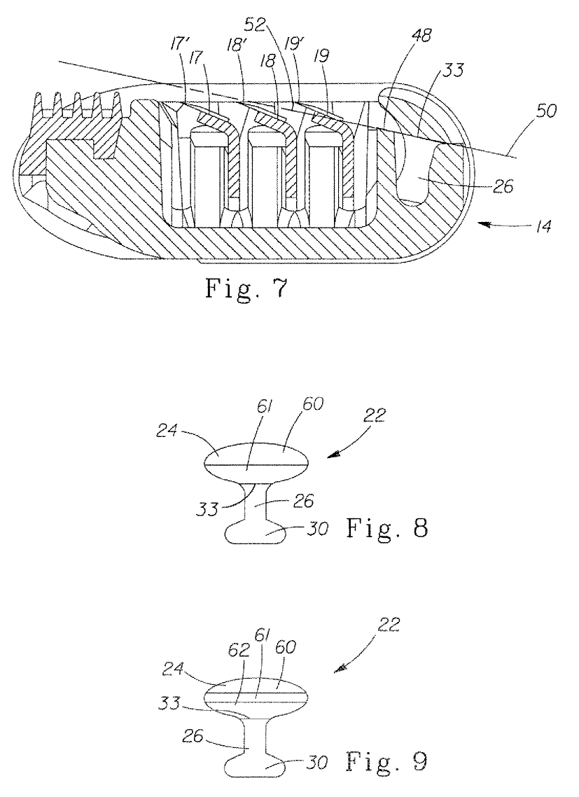

In FIG. 7 the razor cartridge 14 is shown after numerous shaves. The exposure 52 of the cap blade 19 after numerous shaves is about +0.3 mm. The exposure of the cap blade 19 after numerous shaves is measured with reference to plane 50 tangential to the edge 18′ of the adjacent blade 18 and the cap edge 48 and the upper surface 33 of base layer 26. After the numerous shaves the entire upper layer has eroded away and thus the upper surface and lower surface of the upper layer 24 are no longer present. The location of the upper surface 33 of the base layer 26 is positioned substantially equivalent to or aligned with the cap edge 48.

The end of optimal shave performance is reached when the entire upper layer 24 has eroded away. At this point in time the edge 18′ of the adjacent blade 18, the cap edge 48 and the upper surface 33 of the base layer 26 define the exposure of the cap blade 19. This situation is a very short period of time as any additional shaves will start to erode the base layer 26. Once erosion of the base layer 26 has started the exposure of the cap blade 19 will be defined by the edge 18′ of the adjacent blade 18 and the cap edge 48 as the position of these two elements is forever fixed.

Thus, having the dividing line between the upper layer 24 and the base layer 26 positioned substantially equivalent to or aligned with the cap edge 48 provides an indication that directly correlates with the change between an optimal shave performance and a sub-optimal shave performance. The dividing line between the upper layer 24 and the base layer 26 may be defined by the upper surface 33 of the base layer 28.

Referring to FIG. 8 skin engaging member 22 includes an exposed lengthwise-extending erodible skin engaging upper layer or portion 24 and a lengthwise-extending erodible skin engaging base layer or portion 26 positioned below the upper layer 24. The base layer 26 preferably extends under the upper layer 24 and provides support for upper layer 24. Base layer 26 also includes connecting portion 30 which serves to lock the skin engaging member into a mating receiving portion of the cartridge. Base layer 26 has an upper surface 33.

The upper layer 24 includes two upper layers 60 and 61. Upper layer 60 is preferably colored green and upper layer 61 is preferably colored yellow.

Referring to FIG. 9 skin engaging member 22 includes an exposed lengthwise-extending erodible skin engaging upper layer or portion 24 and a lengthwise-extending erodible skin engaging base layer or portion 26 positioned below the upper layer 24. The base layer 26 preferably extends under the upper layer 24 and provides support for upper layer 24. Base layer 26 also includes connecting portion 30 which serves to lock the skin engaging member into a mating receiving portion of the cartridge. Base layer 26 has an upper surface 33.

The upper layer 24 includes three upper layers 60, 61 and 62. Upper layer 60 is preferably colored green, upper layer 61 is preferably colored yellow and upper layer 62 is preferably colored white.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising a guard, a cap and a plurality of blades each with sharpened edges located between the guard and the cap, the cap comprising a cap edge positioned nearest the blades and an erodible skin engaging member,
said plurality of blades comprising a cap blade defining a blade edge nearest the cap and an adjacent blade defining a blade edge positioned immediately adjacent to the cap blade and between the cap blade and the guard,
said skin engaging member comprising
at least one upper layer comprising an erodible skin engaging layer of a first color, said upper layer having an upper surface, a lower surface and a first thickness dimension,
a base layer positioned below said upper layer comprising an erodible skin engaging layer of a second color different from said first color, said base layer having an upper surface, a lower surface and a thickness dimension, and
said upper layer eroding during shaving exposing said upper surface of said base layer, said upper surface of said base layer being positioned relative to the cap edge such that when said upper layer has eroded the cap blade edge has a final exposure defined by the adjacent blade edge, the cap edge and the upper surface of the base layer.

2. The razor cartridge of claim 1, wherein said first color is green.

3. The razor cartridge of claim 1, wherein said second color is red.

4. The razor cartridge of claim 1, wherein said second color is white.

5. The razor cartridge of claim 1, wherein said upper layer and said base layer each comprise a solid polymeric material.

6. The razor cartridge of claim 1, wherein said upper layer and said base layer each comprises a water soluble shaving aid and a water insoluble polymer.

7. The razor cartridge of claim 1, wherein said upper surface of said upper layer is positioned relative to said cap edge such that prior to use the cap blade edge has a first exposure defined by the adjacent blade edge and the upper surface of said upper layer.

8. The razor cartridge of claim 7, wherein said final exposure is greater than first exposure.

9. The razor cartridge of claim 1, wherein said upper layer comprises two layers.

10. The razor cartridge of claim 1, wherein said upper layer comprises three layers.

11. A razor cartridge comprising a guard, a cap and a plurality of blades each with sharpened edges located between the guard and the cap, the cap comprising a cap edge positioned nearest the blades and an erodible skin engaging member,
said plurality of blades comprising a cap blade defining a blade edge nearest the cap and an adjacent blade defining a blade edge positioned immediately adjacent to the cap blade and between the cap blade and the guard,
said skin engaging member comprising
at least one upper layer comprising an erodible skin engaging layer of a first color, said upper layer having an upper surface, a lower surface and a first thickness dimension,
a base layer positioned below said upper layer comprising an erodible skin engaging layer of a second color different from said first color, said base layer having an upper surface, a lower surface and a thickness dimension, and
said upper layer eroding during shaving exposing said upper surface of said base layer to provide a color change that signals to a user that the cartridge should be replaced, said upper surface of said base layer being positioned relative to the cap edge such that when said upper layer has eroded the cap blade edge has a final exposure defined by the adjacent blade edge, the cap edge and the upper surface of the base layer.

12. The razor cartridge of claim 11, wherein said first color is green.

13. The razor cartridge of claim 11, wherein said second color is red.

14. The razor cartridge of claim 11, wherein said second color is white.

15. The razor cartridge of claim 11, wherein said upper layer and said base layer each comprise a solid polymeric material.

16. The razor cartridge of claim 11, wherein said upper layer and said base layer each comprises a water soluble shaving aid and a water insoluble polymer.

17. The razor cartridge of claim 11, wherein said upper surface of said upper layer is positioned relative to said cap edge such that prior to use the cap blade edge has a first exposure defined by the adjacent blade edge and the upper surface of said upper layer.

18. The razor cartridge of claim 17, wherein said final exposure is greater than first exposure.

19. The razor cartridge of claim 11, wherein said upper layer comprises two layers.

20. The razor cartridge of claim 11, wherein said upper layer comprises three layers.
